(19) United States
(12) Patent Application Publication
(10) Pub. No.: US 2011/0078016 A1
(43) Pub. Date: Mar. 31, 2011

(54) MARKETING CALENDAR EVENT ORGANIZATION

(75) Inventors: Timo WAGENBLATT, Bornheim (DE); Sandra BICKER, Heidelberg (DE); Andreas PAFFENHOLZ, Troisdorf (DE); Susann STIELER, Leimen (DE); Martin SCHREPP, Hockenheim (DE)

(73) Assignee: SAP AG, Walldorf (DE)

(21) Appl. No.: 12/570,532

(22) Filed: Sep. 30, 2009

(51) Int. Cl. G06Q 10/00; G06Q 30/00; G06F 3/048

(52) U.S. Cl. 705/14.43; 715/853

(57) ABSTRACT

A processor may read structure information from a database stored on a computer-readable storage medium. The structure information may be associated with a marketing calendar application and the structure information may represent one or more clusters and ordering information for the one or more clusters. The processor may read cluster information for the one or more clusters from the database. The cluster information may represent one or more related marketing activities, viewing information and grouping information. The processor may present the one or more clusters on a display device based upon the ordering information for the one or more clusters. The processor may present on the display device the one or more related marketing activities based upon the viewing information and the grouping information.

### BACKGROUND

Many enterprise software applications include a calendar that may be used to store and view activities in an organized manner. One such type of calendar is a marketing calendar. A marketing calendar may be the starting point for the organization of marketing activities for a marketing user. Examples of marketing users may be a marketing manager, brand manager or sales director. A marketing calendar may present marketing events to a marketing user during all phases of a marketing project, such as planning, execution or evaluation.

The aim of marketing activities, such as product launch campaigns, may be to increase brand awareness, market share and sales volume. In order to achieve this goal, all of these marketing activities may be included in a cross-enterprise, global marketing and sales strategy. Marketing activities should be aligned such that they complement and strengthen each other, rather than seeking to run independently of each other. A marketing calendar may be used as a central entry point to provide a working area that gives a marketing user an overview of all marketing activities within a certain time range.

In large organizations, marketing activities may number in the thousands. A single marketing user may need to keep track of many marketing activities, however, it may not be necessary for each marketing user to view or edit every marketing activity within an entire organization. In addition, several different marketing users may need access to one or more common marketing activities. Therefore, a need exists for a marketing calendar solution that allows a large number of marketing activities to be organized and accessed by the marketing users. Further, a need exists for a marketing calendar solution that presents marketing activities to marketing users based upon each users' particular preferences and role within an organization.

### BRIEF DESCRIPTION OF THE DRAWINGS

FIG. 1 is a system according to an embodiment of the present invention.

FIG. 2 is a logic flow according to an embodiment of the present invention.

FIG. 3 illustrates cluster objects according to an embodiment of the present invention.

FIG. 4 illustrates cluster objects according to an embodiment of the present invention.

FIG. 5 illustrates structure objects according to an embodiment of the present invention.

FIG. 6 illustrates a graphical user interface according to an embodiment of the present invention.

FIG. 7 illustrates a graphical user interface according to an embodiment of the present invention.

FIG. 8 illustrates a graphical user interface according to an embodiment of the present invention.

FIG. 9 illustrates a graphical user interface according to an embodiment of the present invention.

FIG. 10 illustrates a graphical user interface according to an embodiment of the present invention.

### DETAILED DESCRIPTION

An embodiment of the present invention may include a computer system that may read structure information from a database stored on a computer-readable storage medium. The structure information may be associated with a marketing calendar application and the structure information may represent one or more clusters and ordering information for the one or more clusters. The processor may read cluster information for the one or more clusters from the database. The cluster information may represent one or more related marketing activities, viewing information and grouping information. The processor may present the one or more clusters on a display device based upon the ordering information for the one or more clusters. The processor may present on the display device the one or more related marketing activities based upon the viewing information and the grouping information.

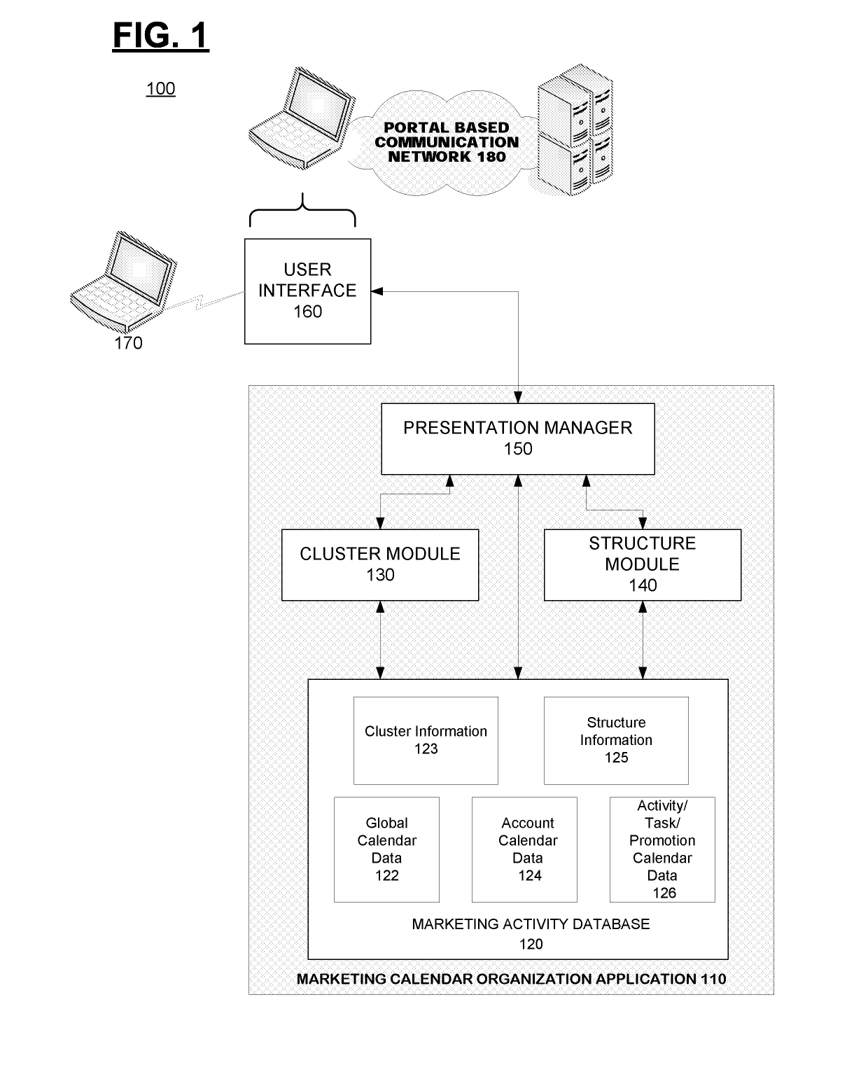

FIG. 1 illustrates system 100 according to an embodiment of the present invention. System 100 may include marketing calendar organization application 110. A marketing calendar may represent one or more calendars or marketing activities associated with marketing promotions or other marketing-related events. Marketing calendar organization application 110 may include marketing activity database 120. Marketing activity database 120 may include data to be included within one or more types of marketing calendars, cluster information and structure information.

In an embodiment of the present invention, marketing activity database 120 may include global calendar data 122. A global calendar may define all events that are of global interest for marketing users. The global calendar may represent external marketing opportunities for all marketing users within an organization. External marketing events may include holidays such as Christmas, events such as the Super Bowl or shopping seasons such as back-to-school. The global calendar may also include internal key marketing events. Internal key marketing events may include package changes or new brand launches for particular clients. A marketing calendar application may use global calendar data 122 to generate a marketing calendar to present to a marketing user on a display device.

In an embodiment of the present invention, marketing activity database 120 may include account calendar data 124. An account calendar may include account specific timeframes where a particular client account has scheduled promotions for certain product categories. For example, a particular client may like to schedule a yogurt promotion in the month of March at their East Coast retail stores. This information may be vital for account planners as this is another general condition to consider when creating campaigns or promotional plans. A marketing calendar application may use account calendar data 124 to generate a marketing calendar to present to a marketing user on a display device.

In an embodiment of the present invention, marketing activity database 120 may include activity/task/promotion calendar data 126. An activity/task/promotion calendar may include Gantt-like visualizations of marketing activities, tasks and promotions. Whereas global calendars and account calendars build the framework and foundation for marketing activities, the activity/task/promotion calendar may be the actual working area of most marketing users. The activity/task/promotion calendar may be where marketing managers view and edit their activities whether the activities are planned, in progress or already executed. A marketing calendar application may use activity/task/promotion calendar data 126 to generate a marketing calendar to present to a marketing user on a display device.

In an embodiment of the present invention, marketing activity database 120 may include cluster information 123. Cluster information 123 may include parameters, attributes and other data necessary to create a cluster of marketing activity information. For example, cluster information 123 may include one or more related marketing activities, viewing information and grouping information. A cluster may represent a set of marketing project types or marketing activities that should be displayed together within a marketing calendar. A cluster may be formed by associating marketing projects and activities with each other. For example, a cluster may be formed by combining all marketing projects of the same type. Alternatively, a cluster may be formed by combining all activities that are associated with a common objective. In an embodiment of the present invention, marketing calendar organization application 110 may include a filter search for clusters that may be used for advanced search capabilities or in conjunction with other filter searches. Mapping marketing projects and activities into clusters may allow search results to be more accurate and include related marketing information. A cluster may be viewed within marketing calendar organization application 110 as a hierarchical tree structure including a series of nodes. Each node may be expanded or collapsed. When expanded, a parent node may display a series of child nodes. When a parent node is collapsed, any child nodes will be hidden from view, leaving only the collapsed parent node in view.

In an embodiment of the present invention, marketing activity database 120 may include structure information 125. Structure information 125 may include information necessary to present a structure within a marketing calendar. For example, structure information 125 may identify one or more clusters and ordering information for the one or more clusters. A structure may include a group of clusters identified within structure information. In this manner, a customized group of global calendars, account calendars and activity/task/promotion calendars may be viewed by a marketing user. In addition to identifying one or more clusters to be included within a structure, structure information may include ordering information that may represent a particular order for the one or more identified clusters.

In an embodiment of the present invention, structure information may further identify a role for a marketing user. For example, there may be several different types of marketing users within an organization. These may include key account managers responsible for the execution of given marketing initiatives for accounts and for developing and monitoring sales and promotion plans, brand managers responsible for the management of a specific brand to meet targets or objectives, finance managers responsible for providing budgets and financial measures for the execution of trade promotions and for tracking overall spending to avoid financial gaps and manage budget re-allocations, trade marketing managers responsible for marketing strategies directed at particular channels, area managers responsible for managing and monitoring day to day sales and service operations of their assigned territories to achieve their sales, delivery and merchandising goals, sales directors responsible for developing and applying the sales strategy and objectives and for the monitoring of sales plans and marketing managers responsible for overall corporate positioning as well as brand marketing initiatives. Each of these roles may require different marketing calendar information.

In an embodiment of the present invention, a role identified by structure information may define a particular group of clusters to be included within the structure. Further, a role identified by structure information may define the order of the clusters included within the structure. Still further, a role identified by structure information may define the initial view of the structure. The initial view of the structure may include which nodes within a hierarchical tree are initially expanded and collapsed. A role identified by structure information may define whether marketing calendar information contained within a cluster may be edited by the marketing users. For example, a key account manager may only have access to a “display only” mode for certain marketing calendar information for a particular territory. An area manager may have full access to edit the same marketing calendar information for the particular territory to which she is assigned.

In an embodiment of the present invention, marketing calendar organization application 110 may include cluster module 130. Cluster module 130 may be a set of software instructions stored on a computer-readable storage medium and executed by a processor. Cluster module 130 may be responsible for accessing cluster information 123 from marketing activity database 120.

In an embodiment of the present invention, marketing calendar organization application 110 may include structure module 140. Structure module 140 may be a set of software instructions stored on a computer-readable storage medium and executed by a processor. Structure module 140 may be responsible for accessing cluster information 123 from marketing activity database 120.

In an embodiment of the present invention, marketing calendar organization application 110 may include presentation manager 150. Presentation manager 150 may be a set of software instructions stored on a computer-readable storage medium and executed by a processor. Presentation manager 150 may be responsible for directing cluster module 130 and structure module 140 to obtain cluster information 123 and structure information 125, respectively. Presentation manager 150 may be responsible for processing received structure information. For example, structure module 140 may send structure information to presentation manager 150 that indicates that particular clusters should be included within a marketing calendar. Presentation manager 150 may then obtain the required cluster information from cluster module 130 and the required marketing calendar information from marketing activity database 120. Presentation manager 150 may be responsible for processing received cluster information and presenting marketing data from marketing activity database 120 accordingly. Once the information required to display marketing data has been processed by presentation manager 150, presentation manager 150 may send the marketing data to user interface 160.

In an embodiment of the present invention, user interface 160 may be presented on a display connected to computing device 170. Computing device 170 may include a display, processor and one or more computer-readable storage mediums. Further, computing device 170 may be connected to one or more other computing devices over portable based communication network 180.

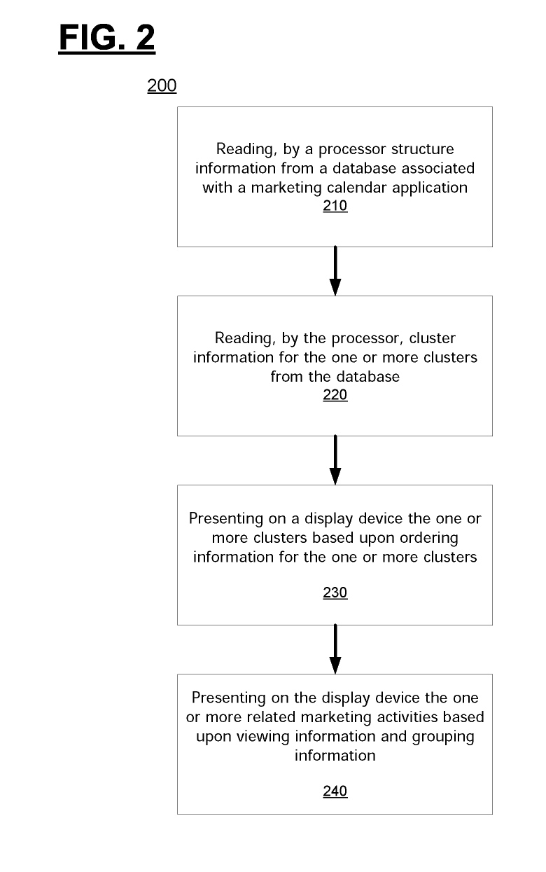

FIG. 2 illustrates logic flow 200 according to an embodiment of the present invention. At step 210, a processor reads structure information from a database associated with a marketing calendar application. Structure information may identify one or more clusters, ordering information and role information. Ordering information may represent a particular order to present the one or more clusters. Role information may identify a particular marketing user role associated with a marketing calendar.

At step 220, a processor may read cluster information for one or more clusters identified by the read structure information. Cluster information may include one or more related marketing activities, viewing information and grouping information. Grouping information may include one or more grouping rules for the one or more related marketing activities. Grouping rules may be based on attributes of the one or more marketing activities. For example, grouping can be based upon promotion type, account, or a grouping identifier.

At step 230, the one or more clusters may be displayed on a display device based upon received ordering information. At step 240, one or more marketing activities identified by one or more clusters may be presented on a display device based upon received viewing information and grouping information.

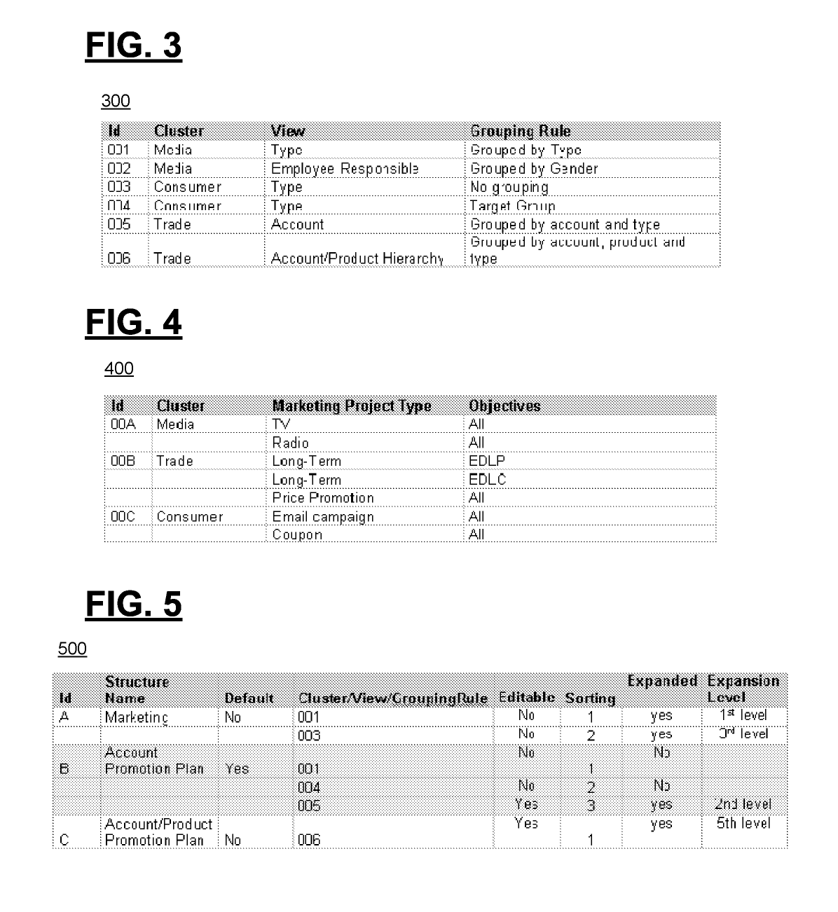

FIG. 3 illustrates cluster objects 300 according to an embodiment of the present invention. In an embodiment, cluster objects 300 may be stored within a database, such as marketing activity database 120. Each cluster may be identified by a unique identification number, as shown within the “Id” field. Each cluster may further be assigned a cluster name, which is shown within the “Cluster” field. The cluster name may be used to identify the cluster within a graphical user interface. In an embodiment, each cluster may be assigned a view. The view may identify a particular viewing preference for marketing events displayed within a cluster. For example, the view may indicate that marketing activities should be presented by type, employee responsible, account or by product. Each cluster may further include a grouping rule. A grouping rule may define how marketing events presented within a marketing calendar may be organized or otherwise associated with each other. For example, a grouping rule may define that marketing activities are grouped by type, target group or account. In an employee responsible view, employees may be grouped by gender.

FIG. 4 illustrates cluster objects 400 according to an embodiment of the present invention. In an embodiment, cluster objects 400 may be stored within a database, such as marketing activity database 120. Cluster objects 400 illustrate the relationship between clusters, marketing project types and objectives. For example, each cluster, along with a unique identifier and name, may include a field for marketing project type and objectives. Marketing project type defines a particular category for a marketing project. For example, a marketing project type may be TV, radio, long-term, price promotion, email campaign or coupon. A particular marketing user may desire to utilize a cluster that displays only a particular marketing project type. For example, a manager in charge of TV advertising may only be interested in viewing marketing activities that have been classified as TV. In an embodiment of the present invention, cluster objects 400 may include an objective for each cluster. The objective may identify a particular goal for a marketing campaign. For example, objectives may include every day low price programs (EDLP), increase brand awareness, avoid churn or increase revenue.

FIG. 5 illustrates structure objects 500 according to an embodiment of the present invention. In an embodiment, structure objects 500 may be stored within a database, such as marketing activity database 120. Structure objects 500 may include a plurality of records, each record representing a structure to be presented within a marketing calendar. Each structure may include a unique identifier. The unique identifier may be used to identify the structure within a marketing calendar application or enterprise software system. Each structure may include a name, which may be customized by a marketing user. The structure name may be used to identify structures within a viewing preferences window of a marketing calendar application. In this manner, a marketing user can quickly identify which structures should be displayed within their personal marketing calendar.

In an embodiment of the present invention, each structure may include a default value. The default value may be a Boolean value indicating true or false, yes or no. Based upon the default value, the structure will be visible by default when opening a marketing calendar application. The default value may be defined by a marketing user's role or edited by a user through interaction with a graphical user interface displaying a preference pane within a marketing calendar application. In an embodiment, each structure may include one or more cluster identifiers. Each cluster identifier represents a cluster with viewing information and grouping information. A single structure may include multiple clusters. However, a cluster may not be duplicated within the same structure.

In an embodiment of the present invention, each structure object may include one or more parameters for each identified cluster. For example, within structure objects 500, Marketing structure A includes two clusters: 001 and 003. Several parameters may be available for 001 and 003, such as editable, sorting, expanded and expansion level. The editable field may be used to define whether a marketing user should have access to edit the marketing activities associated with the cluster. The editable attribute may be determined based upon the role of a marketing user. If the value is “no,” the cluster will be displayed to the marketing user in a display-only mode. If the value is “yes,” the cluster will be fully editable by the marketing user.

In an embodiment of the present invention, each identified cluster may include a ordering or sorting parameter. The sorting parameter defines the order in which each of a plurality of clusters should be presented to the user of a marketing calendar application. Like the other parameters, the sorting parameter may be based upon user customization or based upon a user role. Each identified cluster may include a Boolean value for whether the cluster should be expanded. As previously disclosed, each cluster may include a hierarchical tree of nodes associated with marketing activities. A hierarchical tree may contain a plurality of parent nodes, which then expand in response to user interaction with a graphical user interface element to display a plurality of child nodes. Likewise, each child node may be expanded to display other child nodes, or grandchildren nodes relative to the original parent nodes, and so on. The expanded parameter identifies whether the initial view of a cluster should be an expanded hierarchical tree or not. If not, the cluster will only display the uppermost parent nodes by default. Of course, a user may later manually expand the nodes as she pleases. If the expanded parameter indicates a “yes” (i.e. the cluster should be expanded), another parameter exists for the level of expansion that should be performed by default. For example, a cluster may contain 7 levels. In this case, an expansion level may indicate that 3 levels should be expanded by default. The expansion level may be customized by a marketing user or may be defined based upon a role of a marketing user.

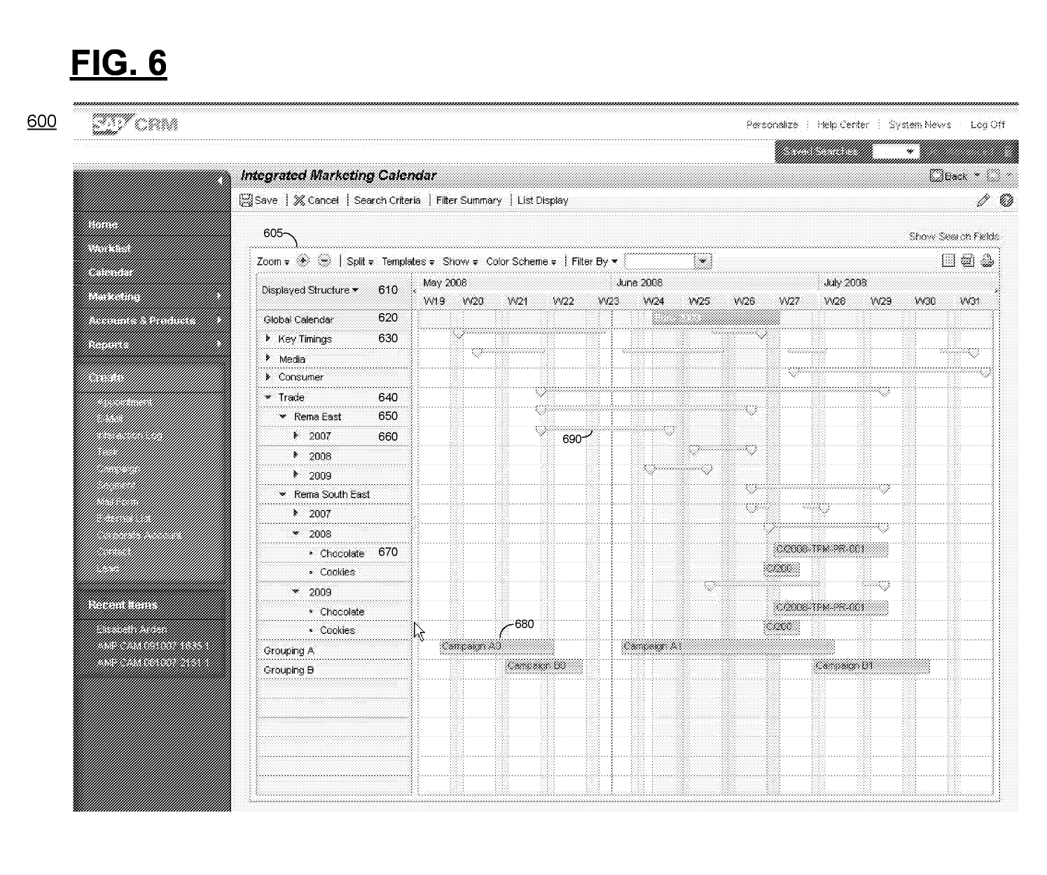

FIG. 6 illustrates a graphical user interface 600 according to an embodiment of the present invention. Graphical user interface 600 may include marketing calendar 605. Marketing calendar 605 may be used to display marketing events and activities from one or more different calendars. Marketing calendar 605 may include structure 610. Structure 610 may include one or more clusters, each cluster associated with specific viewing and grouping information. For example, structure 610 may include global calendar 620. A global calendar may define all events that are of global interest for marketing users. The global calendar may represent external marketing opportunities for all marketing users within an organization. External marketing events may include holidays such as Christmas, events such as the Super Bowl or shopping seasons such as back-to-school. The global calendar may also include internal key marketing events. Internal key marketing events may include package changes or new brand launches for particular clients.

In an embodiment of the present invention, structure 610 may include Key Timings cluster 630. Key Timings cluster 630 may define all key marketing events within an organization, such as package changes or new brand launches. In an embodiment of the present invention, structure 610 may include additional activity/task/promotion calendars. An activity/task/promotion calendar may include Gantt-like visualizations of marketing activities, tasks and promotions. The activity/task/promotion calendar may be where marketing managers view and edit their activities whether the activities are planned, in progress or already executed. An example activity/task/promotion calendar is illustrated by cluster 640. Cluster 640 may include several children nodes, such as child node 650 indicating a customer and child node 660 indicating a year. Also included within cluster 640 is child node 670, which identifies a particular product.

In an embodiment of the present invention, roles may define particular grouping and viewing information for clusters. Further, roles may define which clusters are to be included within a structure and the order of the included clusters. A marketing user's ability to edit a marketing activity may also be defined by a role associated with the user. Structures may be associated with user roles and clusters may be associated with structures. In this manner, particular user roles have defined structures that include clusters relevant to the particular role.

In an embodiment of the present invention, marketing activities may be displayed using a Gantt chart, as illustrated within marketing calendar 605. When the node corresponding to an activity has been expanded by the user, or by default based upon the structure and cluster parameters, the marketing activity may be visible. For example, marketing activity 680 is visible to a marketing user. However, when a marketing activity is associated with a collapsed node, the marketing activity may not be visible, but instead may be presented as a shaded line. For example, marketing activity 690 is not visible to a marketing user. Further, a marketing calendar may enter a split-calendar view based upon default settings or user interaction with a graphical user interface element. A split-calendar view may display one or more marketing calendars within the same window, each marketing calendar including its own structures and corresponding clusters. A user may be able to manipulate the size of each marketing calendar by manipulating graphical user interface elements associated with the size of each marketing calendar.

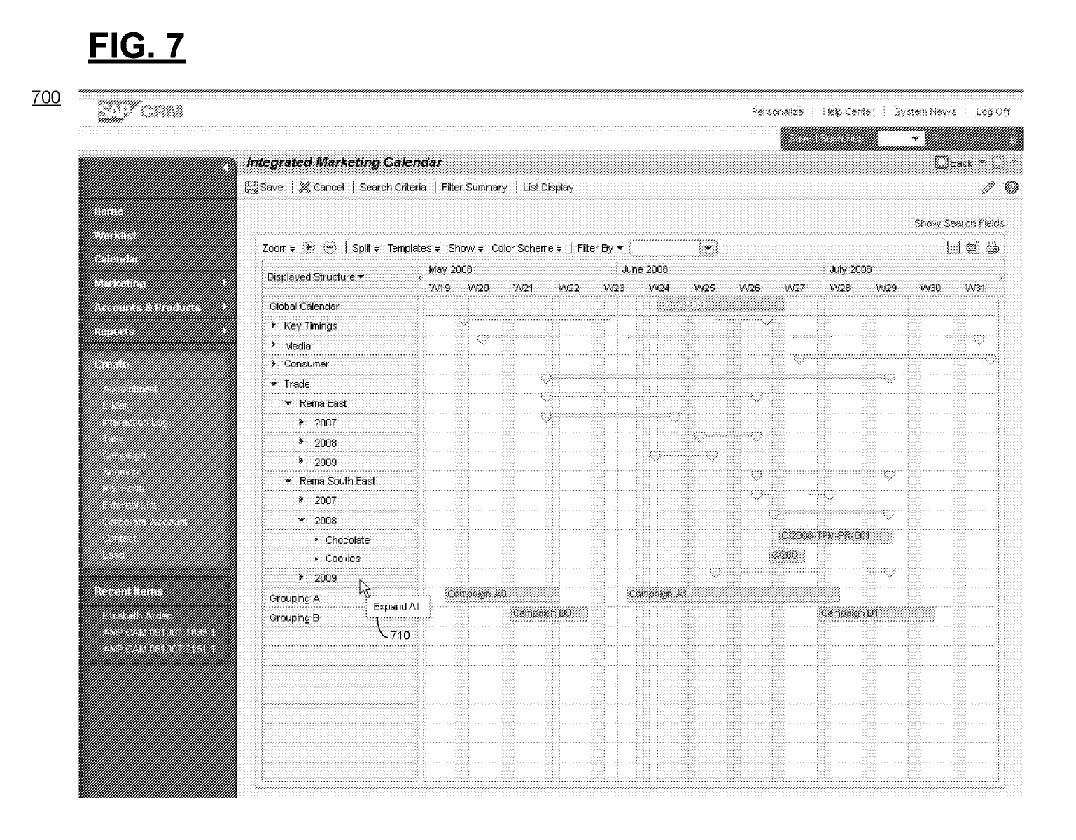

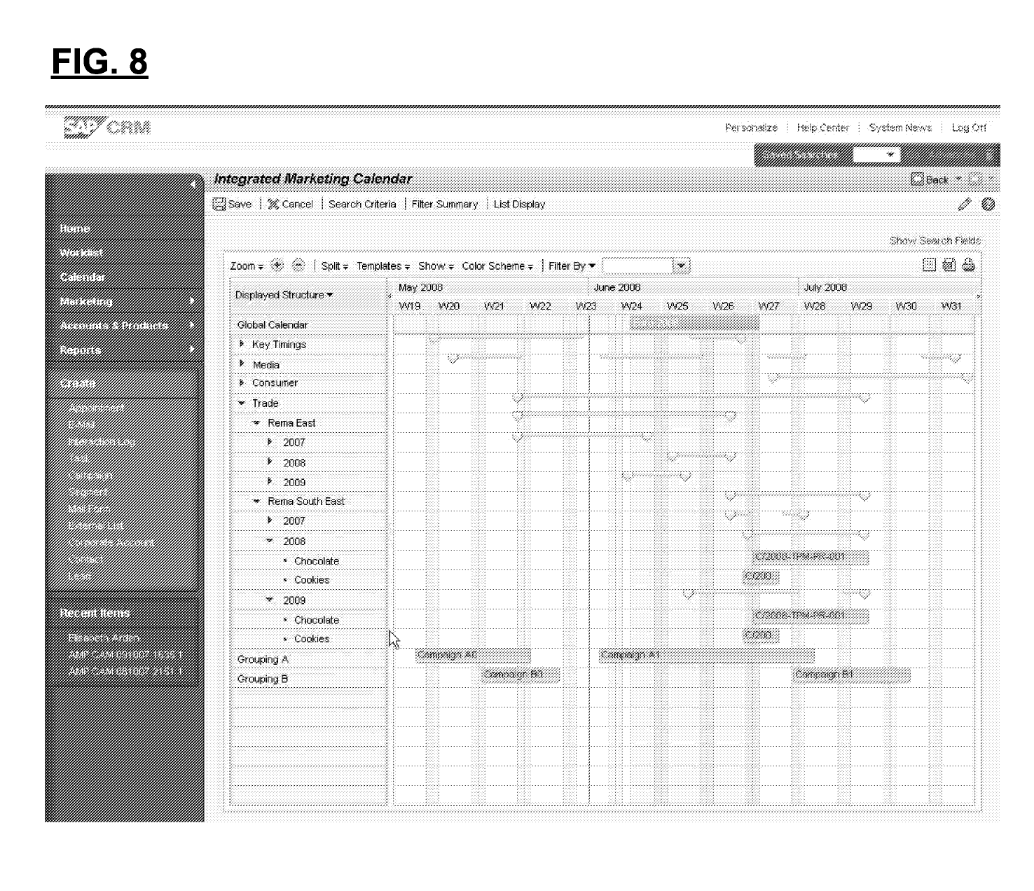

FIG. 7 illustrates a graphical user interface 700 according to an embodiment of the present invention. Graphical user interface 700 illustrates the ability to expand all nodes below a particular node. For example, when a marketing user interacts, possibly through a right-click of a mouse, with a node element, the option to expand all may be present. When a user selects the option to expand all, all nodes subordinate to the selected node will become visible, as disclosed within FIG. 8.

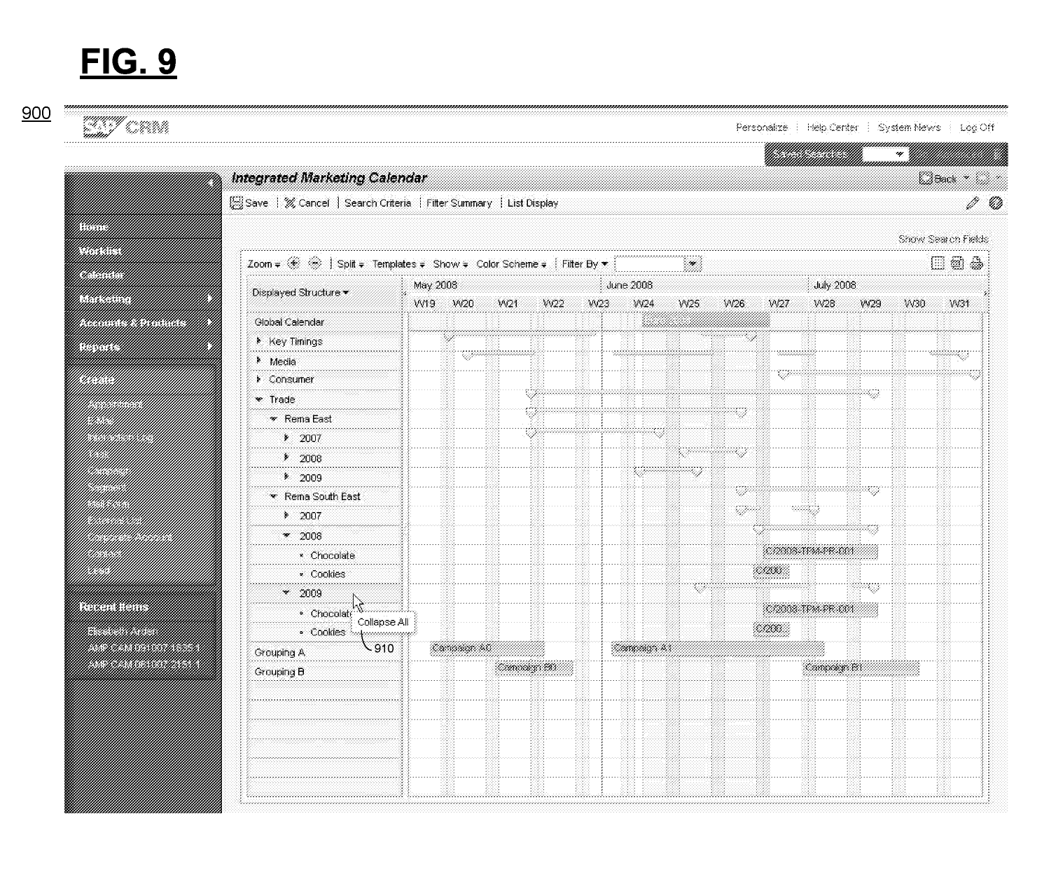

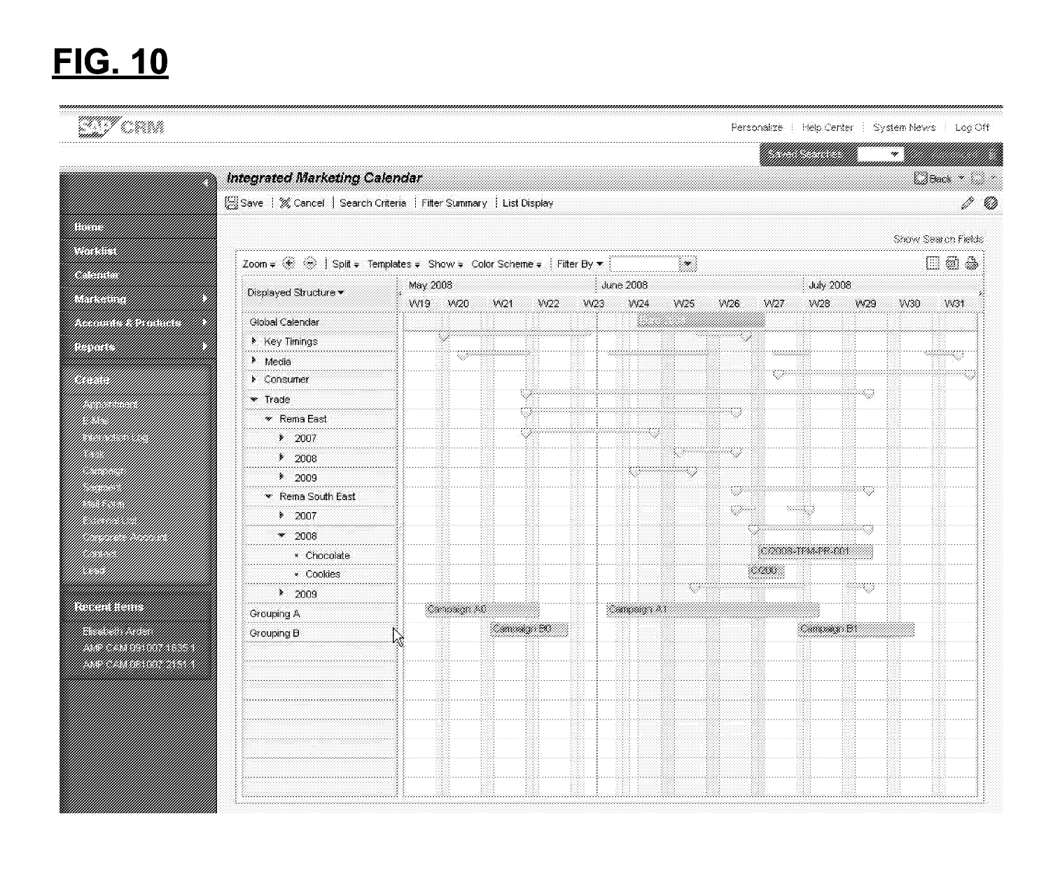

FIG. 9 illustrates a graphical user interface according to an embodiment of the present invention. Graphical user interface 900 illustrates the ability to collapse all nodes below a particular node. For example, when a marketing user interacts, possibly through a right-click of a mouse, with a node element, the option to collapse all may be present. When a user selects the option to collapse all, all nodes subordinate to the selected node will become hidden, as disclosed within FIG. 10.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be implemented, for example, using a computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

We claim:

1. A computer-implemented method comprising the steps of:
reading, by a processor structure information from a database associated with a marketing calendar application, the structure information representing one or more clusters and ordering information for the one or more clusters;
reading, by the processor, cluster information for the one or more clusters from the database, the cluster information representing one or more related marketing activities, viewing information and grouping information;
presenting on a display device the one or more clusters based upon the ordering information for the one or more clusters; and
presenting on the display device the one or more related marketing activities based upon the viewing information and the grouping information.

2. The computer-implemented method of claim 1, wherein the structure information further represents a role.

3. The computer-implemented method of claim 2, wherein the one or more marketing activities are editable by a user based upon the role.

4. The computer-implemented method of claim 1, further comprising the step of expanding the one or more clusters in response to a selection of a user interface element.

5. The computer-implemented method of claim 1, further comprising the step of collapsing the one or more clusters in response to a selection of a user interface element.

6. The computer-implemented method of claim 1, wherein the one or more activities are displayed within the marketing calendar application as a Gantt chart.

7. The computer-implemented method of claim 6, wherein the marketing calendar application includes a split view comprising a plurality of separate Gantt charts.

8. An article comprising a computer-readable storage medium storing instructions that, when executed by a processor, perform the steps of:
reading by a processor structure information from a database associated with a marketing calendar application, the structure information representing one or more clusters and ordering information for the one or more clusters;
reading by the processor cluster information for the one or more clusters from the database, the cluster information representing one or more related marketing activities, viewing information and grouping information;
presenting on a display device the one or more clusters based upon the ordering information for the one or more clusters; and
presenting on the display device the one or more related marketing activities based upon the viewing information and the grouping information.

9. The computer-implemented method of claim 8, wherein the structure information further represents a role.

10. The computer-implemented method of claim 9, wherein the one or more marketing activities are editable by a user based upon the role.

11. The computer-implemented method of claim 8, further comprising the step of expanding the one or more clusters in response to a selection of a user interface element.

12. The computer-implemented method of claim 8, further comprising the step of collapsing the one or more clusters in response to a selection of a user interface element.

13. The computer-implemented method of claim 8, wherein the one or more activities are displayed within the marketing calendar application as a Gantt chart.

14. The computer-implemented method of claim 13, wherein the marketing calendar application includes a split view comprising a plurality of separate Gantt charts.

15. A computer system for managing financial instruments comprising:
a processor;
a computer-readable storage medium; and
a display device;
wherein the processor performs the steps of:
reading structure information from a database stored on the computer-readable storage medium and associated with a marketing calendar application, the structure information representing one or more clusters and ordering information for the one or more clusters;
reading cluster information for the one or more clusters from the database, the cluster information representing one or more related marketing activities, viewing information and grouping information;
presenting on the display device the one or more clusters based upon the ordering information for the one or more clusters; and
presenting on the display device the one or more related marketing activities based upon the viewing information and the grouping information.

16. The computer-implemented method of claim 15, wherein the structure information further represents a role.

17. The computer-implemented method of claim 16, wherein the one or more marketing activities are editable by a user based upon the role.

18. The computer-implemented method of claim 15, further comprising the step of expanding the one or more clusters in response to a selection of a user interface element.

19. The computer-implemented method of claim 15, further comprising the step of collapsing the one or more clusters in response to a selection of a user interface element.

20. The computer-implemented method of claim 15, wherein the one or more activities are displayed within the marketing calendar application as a Gantt chart.

21. The computer-implemented method of claim 20, wherein the marketing calendar application includes a split view comprising a plurality of separate Gantt charts.
